(19) United States
(12) Patent Application Publication
(10) Pub. No.: US 2014/0036242 A1
(43) Pub. Date: Feb. 6, 2014

(54) OPTICAL SCANNING APPARATUS AND OPTICAL SCANNING IMAGE PROJECTION APPARATUS

(71) Applicant: Hitachi Media Electronics Co., Ltd., Oshu-shi (JP)

(72) Inventor: Kunikazu OHNISHI, Yokosuka-shi (JP)

(73) Assignee: Hitachi Media Electronics Co., Ltd., Oshu-shi (JP)

(21) Appl. No.: 13/949,568

(22) Filed: Jul. 24, 2013

(30) Foreign Application Priority Data
Jul. 31, 2012 (JP) 2012-169789

(51) Int. Cl. G02B 26/10; G03B 21/28

(52) U.S. Cl. CPC G02B 26/10; G03B 21/28
USPC 353/94; 359/201.2

(57) ABSTRACT

An optical scanning apparatus is configured to use a composite laser light source element provided with a plurality of semiconductor laser light sources in a single housing and thereby align both the irradiation position and the light flux parallel characteristics of respective laser light fluxes emitted from respective semiconductor laser light sources in the light source element. A light flux synthesis apparatus is used that includes two reflective mirrors inclined at 45 degrees relative to the optical axis of the respective incident light fluxes, and mutually inclined by a predetermined minute relative angle φ. The parallel characteristics of the respective laser light fluxes are aligned by the angle φ imparted to the reflective mirrors, and the irradiation position of the respective laser light fluxes is aligned by imparting predetermined wavelength-selectable characteristics or polarization selectable characteristics in relation to the deflection mirror to reflective surface of the reflective mirror.

### INCORPORATION BY REFERENCE

This application relates to and claims priority from Japanese Patent Application No. 2012-169789 filed on Jul. 31, 2012, the entire disclosure of which is incorporated herein by reference.

### BACKGROUND OF THE INVENTION

(1) Field of the Invention

The present invention relates to an optical scanning apparatus and an optical scanning image projection apparatus, and in particular, relates to a small optical scanning apparatus configured to scan using a light flux in a two-dimensional configuration, and to an optical scanning image projection apparatus using the same.

(2) Description of the Related Art

In recent years, various optical scanning image projection apparatuses have been proposed that include a function of projecting a two-dimensional image onto a projection screen surface by use of an afterimage effect by projecting a light flux that is emitted from a semiconductor laser light source onto a screen surface or the like and scanning the light flux in a two-dimensional configuration on the screen surface by deflection means such as a biaxial deflection mirror or the like.

A configuration in which a composite laser light source is provided with a plurality of semiconductor laser light sources in a single housing is effective to reduce the size in the above type of image projection apparatus of the optical scanning apparatus that is configured to scan a light flux in a two-dimensional configuration.

However, when the above type of composite laser light source is used as the light source of the optical scanning image projection apparatus, a plurality of light fluxes that are emitted from respective semiconductor laser light sources in the composite laser light source must become incident in a configuration of being synthesized into a single light flux onto the screen surface through predetermined deflection means such as a biaxial deflection mirror or the like.

An actual example of optical means for concentrating a plurality of light fluxes into a single light flux includes an example that uses an optical prism as disclosed in U.S. Pat. No. 7,883,214B2.

### SUMMARY OF THE INVENTION

However, U.S. Pat. No. 7,883,214B2 is only configured to align the irradiation position of a plurality of light fluxes on a deflection mirror surface, and does not cause the plurality of light fluxes to adopt a parallel configuration. Therefore, the problem arises that the plurality of light fluxes are again separated before being reflected by the deflection mirror and becoming incident on the screen surface that is the display surface of the image, and as a result, correct image projection is not enabled.

The present invention is proposed in light of the above circumstances, and has the object of providing an optical scanning apparatus, and an optical scanning image projection apparatus using the same, that includes optical means configured to execute irradiation with a correctly aligned configuration and to also avoid separation of the plurality of light fluxes on the display surface by causing the plurality of light fluxes to become incident in a configuration in which both the irradiation position and the parallel characteristics in relation to the deflection mirror are made to substantially coincide.

The above object can be attained by the present invention as disclosed in the scope of the patent claims.

According to the present invention, an optical scanning apparatus, and an optical scanning image projection apparatus using the same, which apparatus is realized that enhances the light flux alignment configuration on the display surface that uses a composite laser light source.

### BRIEF DESCRIPTION OF THE DRAWINGS

These and other features, objects and advantages of the present invention will become more apparent from the following description when taken in conjunction with the accompanying drawings wherein:

FIG. 1 is a schematic figure of an optical system illustrating a first embodiment according to the present invention;

FIG. 2 is a schematic figure that enlarges and displays the main components of an optical system in a first embodiment according to the present invention;

FIG. 3 is a schematic figure of an optical system illustrating a second embodiment according to the present invention; and

FIG. 4 is a schematic figure of an optical system illustrating a third embodiment according to the present invention.

### DETAILED DESCRIPTION OF THE EMBODIMENT

The embodiments of the present invention will be described below making reference to the figures. However, it goes without saying that the present invention is not limited to the configurations of the embodiments described below.

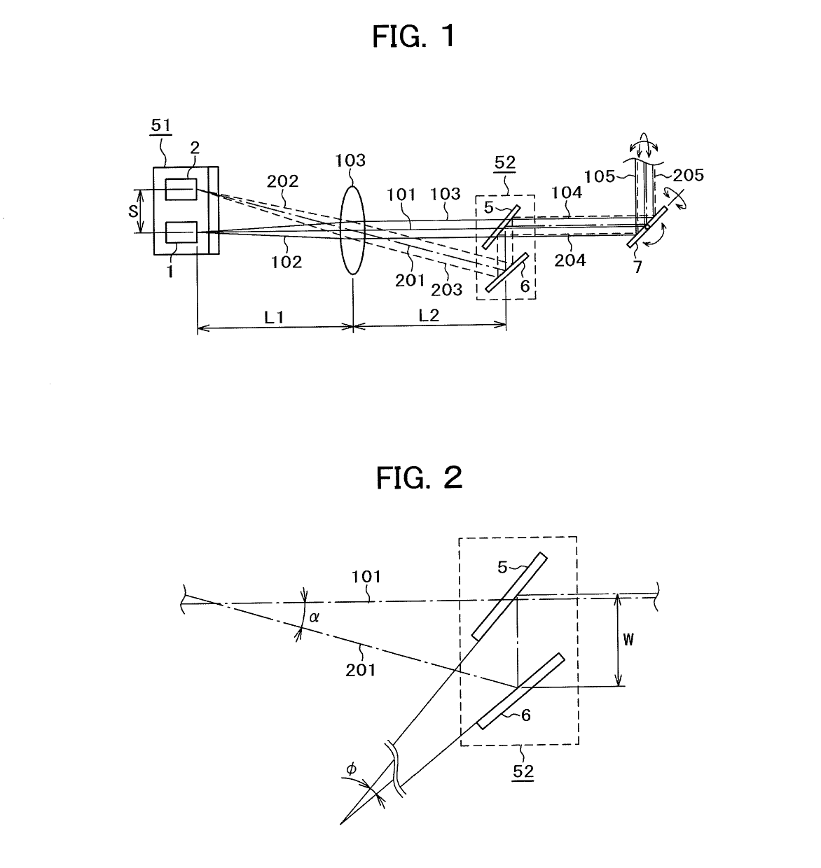

FIG. 1 is a schematic figure illustrating an embodiment of an optical system relating to an optical scanning apparatus, and to an optical scanning image projection apparatus using the same, according to the present invention.

Reference numerals 1 and 2 denote semiconductor laser light sources having mutually different wavelengths. For example, reference numeral 1 is a light source that emits blue laser light having a wavelength in the 400 nm band, and reference numeral 2 is a light source that emits red laser light having a wavelength in the 600 nm band.

The light sources 1 and 2 are housed in one housing 51, and the emission point of the light source 1 is disposed at a position that is made to substantially coincide with the main optical axis of a light flux conversion lens 4 that is disposed in front of the light source 1. On the other hand, the emission point of the light source 2 is disposed at a position that is separated by a predetermined distance S in a substantially vertical direction relative to the main optical axis of the light flux conversion lens 4 relative to the emission point of the light source 1.

However, this configuration is merely an example of a combination of the wavelengths of laser light emitted from the light sources 1, 2 and a combination of the emission point positions, and of course, there is no limitation in relation to the present invention on the type or position of the light source. For example, a configuration in which the both light sources 1, 2 are disposed at a position that is separated by an equal distance from the main optical axis of the light flux conversion lens 4 also falls within the scope of the present invention.

Various emission laser light fluxes 102 and 202 emitted from the semiconductor laser light sources 1, 2 are converted to a substantially parallel light flux or a weakly convergent light flux 103 and 203 respectively through the common light flux conversion lens 4 that is disposed at a position that is separated by a predetermined distance L1 from the respective emission points of the light sources 1 and 2, and become incident on a light flux synthesis unit 52 that is the main component of the present invention.

The central optical axis 101 and 201 of the light fluxes 103 and 203 become incident on the light flux synthesis unit 52 in a configuration that is inclined respectively by a predetermined angle since the light emission points of the light source that emits the respective light fluxes are disposed by separation of a predetermined distance S in a substantially vertical direction relative to the main optical axis of the light flux conversion lens 4 in the housing 51 as described above.

FIG. 2 is a schematic figure that specifically describes the details of the present invention, and enlarges and displays the light flux synthesis unit 52 that is the main component of the present invention in the embodiment illustrated in FIG. 1, and the main optical axes 101 and 201 of the respective incident light fluxes 103 and 203.

The light flux synthesis unit 52 in the present embodiment includes two reflective mirrors 5 and 6. The reflective mirror 5 is configured with a reflectance that enables selection of the wavelength. For example, the blue light flux in the wavelength 400 nm band of the light flux 103 (for example, only the central optical axis 101 is denoted for simplicity in FIG. 2) exhibits a transmittance of at least 90%, and the red light flux in the wavelength 600 nm band of the light flux 203 (for example, only the central optical axis 201 is denoted for simplicity in FIG. 2) is reflected with reflectance of at least 90%. Therefore, the light flux 103 that is incident upon the light flux synthesis unit 52 is directly incident on the wavelength selectable reflective mirror 5 that is disposed in the light flux synthesis unit 52, and then passes through the reflective mirror 5 and is emitted from the light flux synthesis unit 52.

The reflective surface of the reflective mirror 5 is disposed in a configuration that is substantially inclined at 45 degrees relative to the central optical axis 101 of the incident light flux 103. In this manner, the thickness of the reflective mirrors 5 and 6 may be reduced in the optical axis direction of the light flux synthesis unit 52 because the respective positions in the optical axis direction are made to substantially coincide, and thereby the overall dimensions of the optical scanning apparatus can be reduced.

The light flux 203 propagates in a configuration that is inclined by a predetermined angle α relative to the light flux 103, becomes incident upon the light flux synthesis unit 52, and then becomes incident in the reflective mirror 6 that is disposed in an inner portion thereof. The reflective surface of the reflective mirror 6 is disposed to be substantially parallel to the reflective mirror 5, and further is inclined by a minute angle φ in relation to the reflective surface of the reflective mirror 5 so that the central optical axis 201 of the light flux 203 that is reflected on the reflective surface of the reflective mirror 6 becomes incident on the reflective surface at an angle of approximately 90 degrees relative to the central optical axis 101 of the light flux 103, that is to say, at an angle of approximately 45 degrees relative to the reflective surface of the reflective mirror 5.

The relative minute angle φ of the reflective mirror 6 and the reflective mirror 5 is half of the relative angle α between the light flux 203 and the light flux 103 that are incident on the light flux synthesis unit 52.

That is to say,

φ=α/2 (1)

The relative angle α between the light flux 203 and the light flux 103 is expressed as shown below by the distance L1 between the emission point of the light sources 1, 2 and the light flux conversion lens 4, and the relative interval S between the above semiconductor laser light sources 1 and 2.

α≈Tan⁻¹[S/L1] (2)

When the light fluxes 103 and 203 are weakly convergent light fluxes or substantially parallel light fluxes, the distance L1 approximately coincides with the focal distance f of the light flux conversion lens 4.

### That is to say:

L1≈f (3)

Using Equations (1) to (3) above, as a result, the relative minute angle φ can be expressed as written below in terms of f and S.

φ≈(1/2)×Tan⁻¹[S/f] (4)

The provision of the reflective mirror 6 in a configuration that is inclined relative to the reflective mirror 5 by a relative minute angle φ to satisfy Equation (4) enables the light flux 203, which is reflected by the reflective surface of the reflective mirror 6 and reaches the reflective mirror 5 and then is further reflected by the wavelength selectable reflective surface, to describe a substantially parallel optical path at substantially the same position as the light flux 103 as shown in the figure, and to be emitted from the light flux synthesis unit 52 together with the light flux 103.

In FIG. 2, the interval W between the reflective mirror 5 and the reflective mirror 6 in the light flux synthesis unit 52 is expressed by the equation below in terms of the distance L1 (≈f) and the disposition interval L2 of the light flux conversion lens 4 and the reflective mirror 5 and the reflective mirror 6 in the light flux synthesis unit 52.

W=(L2/L1)×S≈(L2/f)×S (5)

The respective light fluxes that are emitted from the light flux synthesis unit 52 describe an optical path that is substantially the same as the respective light fluxes 104 and 204, and become incident on the two-dimensional optical scanning unit 7.

The two-dimensional optical scanning unit 7 includes for example a two-dimensional deflection mirror, and is provided with the function of performing high speed oscillating/rotating driving of the deflection mirror about a substantially vertically rotation axis to thereby execute a two-dimensional high speed scanning operation of the light flux that is reflected by the deflection mirror. After the light fluxes 104 and 204 that have become incident on the two-dimensional scanning unit 7 are reflected by the two-dimensional scanning unit 7, the light fluxes 104 and 204 become light fluxes 105 and 205, and become incident upon the display unit, and in particular, the projection screen (not illustrated) that is disposed at a forward predetermined position of the two-dimensional scanning unit 7 to thereby execute a two-dimensional scan of the display unit. The two-dimensional image is output onto the screen by modulating the light emission intensity of the semiconductor lasers 1 and 2, in synchrony with the two-dimensional scan, according to the image to be displayed.

Although an optical scanning image projection apparatus in which the display unit is integrated with the optical scanning apparatus, or an optical scanning image projection apparatus that includes an output unit for the light fluxes 105 and 205 by disposing the display unit on an outer portion of the optical scanning apparatus could be proposed, both configurations fall within the scope of the present invention.

The details of the modulation method for the emission intensity of the semiconductor laser 1 and 2 that is synchronized with the two-dimensional and the details of the structure of the two-dimensional scanning unit 7 scan have no direct relationship to the present invention, and therefore, details of description have been omitted.

However, although the reflective mirror 5 and the reflective mirror 6 in the light flux synthesis unit 52 according to the embodiment in FIG. 1 and FIG. 2 have been configured as a plane mirror, the present invention is not limited thereby. Next, another embodiment will be described.

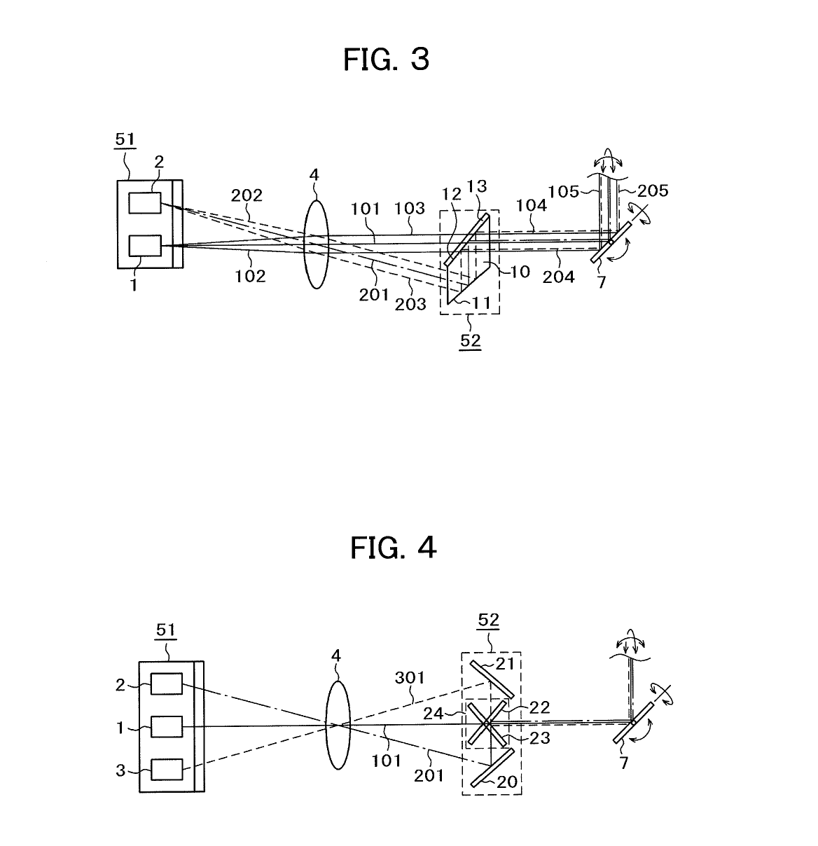

FIG. 3 is a schematic figure illustrating a second embodiment of the present invention. Those elements of configuration that are the same as the embodiment illustrated in FIG. 1 and FIG. 2 are denoted by the same reference numerals.

In the embodiment illustrated in FIG. 3, a trapezoid prism 10 that is configured is disposed with a cross sectional shape that is parallel to the face of the page as illustrated in the figure and formed in the light flux synthesis unit 52 from optical glass or a plastic for use in optical components. With reference to the four prism surfaces that configure the trapezoid cross sectional surface of the prism 10, a prism surface 12 is configured as a reflective mirror including wavelength-selectable and reflectance characteristics that are the same as the reflective mirror 5 in the embodiment illustrated in FIG. 1 and FIG. 2, and a reflective film 13 that exhibits predetermined wavelength-dependent reflectance characteristics is laminated onto the prism surface 12 in order to realize that effect.

On the other hand, the prism surface 11 configures a normal reflective surface, and has the same function as the reflective mirror 6 in the embodiment illustrated in FIG. 1 and FIG. 2. That is to say, the light flux 203 that is incident onto the prism surface 11 is reflected with at least 90% reflectance, propagates in the prism, and is guided onto the surface 12.

In the same manner as the relationship between the reflective mirrors 5 and 6 in the embodiment illustrated in FIG. 1 and FIG. 2, the prism surfaces 11 and 12 exhibit a relative inclination that is expressed by the minute relative angle φ as shown in Equation (4). The interval between the prism surface 11 and the prism surface 12, that is to say, the thickness of the prism 10 is made to substantially coincide with W as expressed in Equation (5).

Furthermore, prism surfaces, other than the prism surfaces 11 and 12, on which the light fluxes 103 or 203 are incident, are configured so that the respective light fluxes are transmitted with a transmittance of at least 90% for example.

However, the reflective mirror 5 or the prism surface 12 in the light flux synthesis unit 52 according to embodiment 1 as illustrated in FIG. 1 to FIG. 3 exhibits wavelength-selectable characteristics so that the light flux 103 can be transmitted and the light flux 203 is reflected. However, the present invention is not limited in this regard. Wavelength-selectable characteristics in a converse configuration are possible in which the light flux 103 is reflected and the light flux 203 is transmitted.

Furthermore, in addition to the example in which the light fluxes 103 and 203 have different wavelengths as in embodiment 1 and embodiment 2 illustrated in FIG. 1 to FIG. 3 in the present invention, a configuration is possible that imparts a function in which the light flux 103 is transmitted or reflected, and at the same time the light flux 203 is reflected or transmitted, by causing the direction of the linearly polarized light to differ by some type of optical means and imparting deflection-direction selectable characteristics to the reflective mirror 5 or the prism surface 12 in the light flux synthesis unit 52.

In the first example and the second example as illustrated in FIG. 1 to FIG. 3, a configuration is disclosed in which two semiconductor laser light fluxes that have mutually different wavelengths are combined, and guided to the two-dimensional optical scanning unit 7. However, a configuration is possible in which some type of optical means is used to combine a third wavelength, for example, 500 nm band of green laser light flux with the light fluxes 103 and 203 and guide the light to the two-dimensional optical scanning unit 7. In this manner, red, green and blue laser light can be combined and become incident through a two-dimensional deflection mirror onto the display unit that is principally the projection screen (not illustrated) and thereby execute a two-dimensional scan on the screen, and in synchrony, it is possible to output a color two-dimensional image onto the screen by separately modulating the emission intensity of the respective colors of laser light flux in response to the image to be displayed.

Furthermore, the semiconductor laser light sources for the three colors of red, green and blue may be housed in the same housing. FIG. 4 illustrates an actual example of this configuration.

FIG. 4 is a schematic figure of a third embodiment according to the present invention, and illustrates an example in which the semiconductor laser light sources 1, 2 and 3 that have mutually different wavelengths are housed in the same housing 51.

In FIG. 4, those elements of configuration that are the same as those described with reference to the examples illustrated in FIG. 1 to FIG. 3 are denoted by the same reference numerals.

The example illustrated in FIG. 4 is configured to dispose a total of four reflective mirrors being reflective mirrors 20 to 23 in the light flux synthesis unit 52.

The reflective mirror 20 is disposed at a position at which the light flux 203 (only the central optical axis 201 is illustrated in the figure for simplicity) that is emitted from the light source 2 becomes incident onto the light flux synthesis unit 52 through the light flux conversion lens 4, and includes the function of guiding the light flux 203 that is reflected to thereby be incident upon the reflective mirrors 22 and 23 as illustrated in the figure.

The reflective mirror 21 is disposed at a position at which the light flux 303 (only the central optical axis 301 is illustrated in the figure for simplicity) that is emitted from the light source 3 becomes incident onto the light flux synthesis unit 52 through the light flux conversion lens 4, and includes the function of guiding the light flux 303 that is reflected to thereby be incident upon the reflective mirrors 22 and 23 as illustrated in the figure.

On the other hand, the reflective mirrors 22 and 23 are disposed at a position at which the light flux 103 (only the central optical axis 101 is illustrated in the figure for simplicity) that is emitted from the light source 1, disposed between the light sources 2 and 3, becomes incident onto the light flux synthesis unit 52 through the light flux conversion lens 4, and are installed so that the reflective surface of the respective reflective mirrors exhibits an angle of approximately ±45 degrees with respect to the central optical axis 101, and both reflective surfaces are in a crossing configuration.

The reflective surface of the reflective mirror 22 allows transmission of, for example, at least 90% of the light flux 103 that is directly incident on the reflective mirror 22 and the light flux 303 that is incident on the reflective surface of the reflective mirror 22 through the reflective mirror 21, and is provided with reflectance characteristics that reflect the light flux 203 that is incident on the reflective surface of the reflective mirror 22 through the reflective mirror 20 with a reflectance of at least 90% for example.

Conversely, the reflective surface of the reflective mirror 23 allows transmission of, for example, at least 90% of the light flux 103 that is directly incident on the reflective mirror 23 and the light flux 203 that is incident on the reflective surface of the reflective mirror 23 through the reflective mirror 20, and is provided with reflectance characteristics that reflect the light flux 303 that is incident on the reflective surface of the reflective mirror 23 through the reflective mirror 21 with a reflectance of at least 90% for example.

Although the reflective surfaces of the reflective mirror 20 and the reflective mirror 22 are substantially parallel and the reflective surfaces of the reflective mirror 21 and the reflective surface of the reflective mirror 23 are substantially parallel, a relative inclination expressed by the minute relative angle φ in Equation (4) is respectively provided.

Even when using a configuration in which the semiconductor laser light sources for the three colors of red, green and blue may be housed in the same housing by use of the light flux synthesis unit 52 that disposes the reflective mirrors 20 to 23, since the light fluxes that are emitted from the respective laser light sources are combined, are propagated on substantially the same light path, and can be guided to the display unit that is principally the projection screen through the two-dimensional optical scanning unit 7, the optical scanning apparatus and an image projection apparatus using the same can be downsized, and are extremely useful for improving the synthesis state of light flux on the screen.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical scanning apparatus configured to scan using emitted light and display an image, the apparatus comprising:
a composite laser light source unit that includes at least two laser light sources, and is configured so that the respective laser light sources produce and emit a laser light flux corresponding to the image;
a light flux conversion lens configured so that the respective laser light fluxes emitted by the composite laser light source unit become incident, and the respective laser light fluxes are converted to a weakly convergent or substantially parallel laser light flux and are emitted;
a light flux synthesis unit configured so that the respective laser light fluxes emitted by the light flux conversion lens become incident, and the inclination in relation to the position of the respective laser light fluxes are made to substantially coincide, and the fluxes are emitted; and
a two-dimensional optical scanning unit including an optical reflective surface configured so that the laser light fluxes emitted by the light flux synthesis unit become incident, and driven in a direction of repetitive deflection in two substantially orthogonal directions, the two-dimensional optical scanning unit reflecting the laser light flux on the optical reflective surface, and emitting the light flux as a two-dimensional scan.

2. The optical scanning apparatus according to claim 1, wherein the light flux synthesis unit includes a reflective mirror separately provided in relation to the respective incident laser light fluxes, and the optical axis of the incident light fluxes is configured with an angle of incidence of substantially 45 degrees relative to the reflective surface of the reflective mirror.

3. The optical scanning apparatus according to claim 2, wherein the angle of the reflective surface of the respective reflective mirrors is mutually different.

4. The optical scanning apparatus according to claim 3, wherein the relative angle φ of the reflective surface of the respective reflective mirrors is given by
φ≈(1/2)×tan⁻¹[S/f]
wherein the focal point distance of the light flux conversion lens is denoted as f, and the interval between the respective laser light sources is S.

5. The optical scanning apparatus according to claim 2, wherein the respective laser light sources included in the composite laser light source unit produce a laser light flux having different wavelengths, and the reflectance of the laser light flux in relation to at least one of the reflective mirrors of the reflective mirrors included in the light flux synthesis unit exhibits wavelength-selectable characteristics.

6. The optical scanning apparatus according to claim 2, wherein the respective laser light sources included in the composite laser light source unit produce a laser light flux of linearly polarized light that differs in relation to the direction of polarization, and the reflectance of the laser light flux in relation to at least one of the reflective mirrors of the reflective mirrors included in the light flux synthesis unit exhibits polarization direction selectable characteristics.

7. An optical scanning image projection apparatus comprising the optical scanning apparatus according to claim 1, and a laser light flux output unit configured to display an image based on the laser light flux emitted by the two-dimensional optical scanning unit on a display unit provided in an external portion of the optical scanning apparatus.

8. An optical scanning image projection apparatus comprising the optical scanning apparatus according to claim 1, and a display unit on which the laser light flux emitted by the two-dimensional optical scanning unit becomes incident, and configured to display an image based on the laser light flux.

9. An optical scanning apparatus configured to scan using emitted light and display an image, the apparatus comprising:
a composite laser light source unit that includes a total of three laser light sources, being red light, green light and blue light, and configured so that the respective laser light sources produce and emit a laser light flux corresponding to the image;
a light flux conversion lens configured so that the respective laser light fluxes emitted by the composite laser light source unit become incident, and the respective laser light fluxes are converted to a weakly convergent or substantially parallel laser light flux, and the fluxes are emitted;
a light flux synthesis unit configured so that the respective laser light fluxes emitted by the light flux conversion lens become incident, and the inclination in relation to the position of the respective laser light fluxes is made to substantially coincide, and the fluxes are emitted; and
a two-dimensional optical scanning unit including an optical reflective surface configured so that the laser light fluxes emitted by the light flux synthesis unit become incident, and driven in a direction of repetitive deflection in two substantially orthogonal directions, the two-dimensional optical scanning unit reflecting the laser light flux on the optical reflective surface, and emitting the light flux as a two-dimensional scan.

10. The optical scanning apparatus according to claim 9,
wherein the light flux synthesis unit includes a total of four mirrors, being first to fourth reflective mirrors,
the first reflective mirror reflecting the first laser light flux of the three incident laser light fluxes, and causing the flux to be incident upon the second reflective mirror and the third reflective mirror,
the fourth reflective mirror reflecting the second laser light flux that differs from the first laser light flux of the three incident laser light fluxes, and causing the flux to be incident upon the second reflective mirror and the third reflective mirror,
the second reflective mirror and the third reflective mirror allowing transmission of the third residual laser light flux of the three incident laser light fluxes,
the second reflective mirror allowing transmission of the first incident laser light flux and causing the flux to be incident on the third reflective mirror,
the third reflective mirror allowing transmission of the second incident laser light flux and causing the flux to be incident on the second reflective mirror,
the second reflective mirror reflecting the second incident laser light flux,
the third reflective mirror reflecting the first incident laser light flux, and
the inclination in relation to the position of the first to third laser light fluxes is made to substantially coincide, and the fluxes are emitted to the two-dimensional scanning unit.

11. An optical scanning image projection apparatus comprising the optical scanning apparatus according to claim 10, and a laser light flux output unit configured to display an image based on the laser light flux emitted by the two-dimensional optical scanning unit on a display unit provided in an external portion of the optical scanning apparatus.

12. An optical scanning image projection apparatus comprising the optical scanning apparatus according to claim 10, and a display unit on which the laser light flux emitted by the two-dimensional optical scanning unit becomes incident, and configured to display an image based on the laser light flux.
